(19) United States
(12) Patent Application Publication
(10) Pub. No.: US 2020/0119556 A1
(43) Pub. Date: Apr. 16, 2020

(54) Autonomous Voltage Control for Power System Using Deep Reinforcement Learning Considering N-1 Contingency

(71) Applicants: Di Shi, San Jose, CA (US); Ruisheng Diao, San Jose, CA (US); Zhiwei Wang, San Jose, CA (US); Qianyun Chang, CA (US); Jiajun Duan, San Jose, CA (US); Xiaohu Zhang, San Jose, CA (US)

(72) Inventors: Di Shi, San Jose, CA (US); Ruisheng Diao, San Jose, CA (US); Zhiwei Wang, San Jose, CA (US); Qianyun Chang, CA (US); Jiajun Duan, San Jose, CA (US); Xiaohu Zhang, San Jose, CA (US)

(21) Appl. No.: 16/594,033

(22) Filed: Oct. 6, 2019

Related U.S. Application Data
(60) Provisional application No. 62/744,217, filed on Oct. 11, 2018.

(51) Int. Cl. H02J 3/18; G06N 3/04; G06N 3/08; G05B 13/02; H02J 13/00; H02J 3/00

(52) U.S. Cl. CPC H02J 3/18; G06N 3/0454; G06N 3/0472; H02J 2203/20; G05B 13/027; H02J 13/00002; H02J 3/0012; G06N 3/08

(57) ABSTRACT

Systems and methods are disclosed to control voltage profiles of a power grid by forming an autonomous voltage control model with one or more neural networks as Deep Reinforcement Learning (DRL) agents; training the DRL agents to provide data-driven, real-time and autonomous grid control strategies; and coordinating and optimizing reactive power controllers to regulate voltage profiles in the power grid with a Markov decision process (MDP) operating with reinforcement learning to control problems in dynamic and stochastic environments.

### TECHNICAL FIELD

This invention relates to autonomous control of power grid voltage profiles.

### BACKGROUND

With the fast-growing penetration of renewable energies, distributed energy resources, demand response and new electricity market behavior, conventional power grid with decades-old infrastructure is facing grand challenges such as fast and deep ramps and increasing uncertainties (e.g., the Californian duck curves), threatening the secure and economic operation of power systems. In addition, traditional power grids are designed and operated to withstand N-1 (and some N-2) contingencies, required by NERC standards. Under extreme conditions, local disturbances, if not controlled properly, may spread to neighborhood areas and cause cascading failures, eventually leading to wide-area blackouts. It is therefore of critical importance to promptly detect abnormal operating conditions and events, understand the growing risks and more importantly, apply timely and effective control actions to bring the system back to normal after large disturbances.

Automatic controllers including excitation system, governors, power system stabilizer (PSS), automatic generation control (AGC), etc., are designed and equipped for generator units to maintain voltage and frequency profiles once a disturbance is detected. Traditionally, voltage control is performed at device level with predetermined settings, e.g., at generator terminals or buses with shunts or SVCs. The impact of such a control scheme is limited to the points of connection and their neighboring buses only, if without proper coordination. Massive offline studies are then needed to predict future representative operating conditions and then coordinate various voltage controllers before determining operational rules for use in real time. Manual actions from system operators are still needed on a daily routine to mitigate operational risks that cannot be handled by the existing automatic controls because of the complexity and high dimensionality of modern power grid. These actions include generator re-dispatch deviating from their scheduled operating points, switching capacitors and reactors, shedding loads under emergency conditions, reducing critical path flows, tripping generators, adjusting voltage setpoints of generator terminal buses, and so on. The time of application, duration and size of these manual actions are typically determined offline by running massive simulations considering the projected “worst” operating scenarios and contingencies, in form of decision tables and operational orders. It is very difficult to precisely estimate future operating conditions and to determine optimal controls, leading to the fact that the offline determined control strategies are either too conservative (causing over investment) or risky (causing stability concerns) when applied in real world.

Deriving effective and rapid voltage control commands for real-time conditions becomes critical to mitigate potential voltage issues for a power grid with ever-increasing dynamics and stochastics. Several measures have been deployed by power utilities and independent system operators (ISOs). Performing security assessment in near real time is one example, which can effectively understand the operational risks if a contingency occurs. However, the lack of computing power and sufficiently accurate grid models prevents optimal control actions from being derived and deployed in real time. Machine learning based methods, e.g., decision trees, support vector machines, neural networks, were developed in the past to first train agents using offline analysis and then apply in real time. These approaches focus on monitoring and security assessment, rather than performing and evaluating controls for operation.

To provide coordinated voltage control actions, hierarchical automatic voltage control (AVC) systems with multiple-level coordination were deployed in the field, e.g., in France, Italy and China, which typically consists of 3 levels (primary, secondary and tertiary).

(a) At primary level, automatic voltage regulator is used to maintain local voltage profile, through excitation systems with a response time of several seconds.

(b) At secondary level, control zones, either determined statically or adaptively (e.g., using sensitivity-based approach), need to be formed first where a few pilot buses are identified; the control objective is to coordinate all reactive power resources in each zone for regulating voltage profiles of the selected pilot buses only, with a response time of several minutes.

(c) At tertiary level, the objective is to minimize power losses by adjusting setpoints of those zonal pilot buses while respecting security constraints, with a response time of 15 minutes to several hours.

The core technologies behind these techniques are based on optimization methods using near real-time system models, e.g., AC optimal power flow considering various constraints, which work well majority of the time in the real-time environment; however, certain limitations still exist that may affect the voltage control performance, including:

(1) They require relatively accurate real-time system models to achieve the desired control performance, which highly depend upon real-time EMS snapshots running every few minutes. The control measures derived for the captured snapshots may not function well if significant disturbances or topology changes occur in the system between two adjacent EMS snapshots.

(2) For a large-scale power network, coordinating and optimizing all controllers in a high dimensional space is very challenging, which may require a long solution time or in rare cases, fail to reach a solution. Suboptimal solutions can be used for practical implementation. For diverged cases, the control measures of the previous day or historically similar cases are used.

(3) Sensitivity-based methods for forming controllable zones are subject to high complexity and nonlinearity in a power system in that the zone definition may change significantly with different operating conditions with various topologies and under contingencies.

(4) Optimal power flow (OPF) based approaches are typically designed for single system snapshots only, making it difficult to coordinate control actions across multiple time steps while considering practical constraints, i.e., capacitors should not be switched on and off too often during one operating day.

### SUMMARY OF THE INVENTION

In one aspect, systems and methods are disclosed to control voltage profiles of a power grid by forming an autonomous voltage control model with one or more neural networks as Deep Reinforcement Learning (DRL) agents; training the DRL agents to provide data-driven, real-time and autonomous grid control strategies; and coordinating and optimizing reactive power controllers to regulate voltage profiles in the power grid with a Markov decision process (MDP) operating with reinforcement learning to control problems in dynamic and stochastic environments.

In another aspect, systems and methods are disclosed to control voltage profiles of a power grid that includes measuring states of a power grid; determining abnormal voltage conditions and locating affected areas in the power grid; creating representative operating conditions including contingencies for the power grid; conducting power grid simulations in an offline or online environment; training deep-reinforcement-learning-based agents for autonomously controlling power grid voltage profiles; and coordinating and optimizing control actions of reactive power controllers in the power grid.

In a further aspect, systems and methods are disclosed to control voltage profiles of a power grid includes measuring states of a power grid from phasor measurement units or EMS system, determining abnormal voltage conditions and locating the affected areas in a power network, creating massive representative operating conditions considering various contingencies, simulating a large number of scenarios, training effective deep-reinforcement-learning-based agents for autonomously controlling power grid voltage profiles, improving control performance of the trained agents, coordinating and optimizing control actions of all available reactive power resources, and generating effective data-driven, autonomous control commands for correcting voltage issues considering N-1 contingencies in a power grid.

In yet another aspect, a generalized framework for providing data-driven, autonomous control commands for regulating voltages, frequencies, line flows, economics in a power network under normal and contingency operating conditions. The embodiment is used to create representative operating conditions of a power grid by interacting with various power flow solvers, simulate contingency conditions, and train different types of DRL-based agents for various objectives in providing autonomous control commands for real-time operation of a power grid.

Advantages of the system may include one or more of the following. The system can significantly improve control effectiveness in regulating voltage profiles in a power grid under normal and contingency conditions. To enhance the stability of a single DQN agent, two architecture-identical deep neural networks are used, including one target network and one evaluation network. The system is purely data driven, without the need for accurate real-time system models when making coordinated voltage control decisions, once an AI agent is properly trained. Thus, live PMU data stream from WAMS can be used to enable sub-second controls, which is extremely valuable for scenarios with fast changes like renewable variations and system disturbances. During the training process, the agent is capable of self-learning by exploring more control options in a high dimension by jumping out of local optima and therefore improves its overall performance. The formulation of DRL for voltage control is flexible in that it can intake multiple control objectives and consider various security constraints, especially time-series constraints.

### BRIEF DESCRIPTIONS OF FIGURES

FIG. 1 shows an exemplary framework for autonomous voltage controls for grid operation using deep reinforcement learning.

FIGS. 2A-2B show exemplary architectures for designing the DRL-based autonomous voltage control method for a power grid.

FIG. 3 shows an exemplary reward definition for voltage profiles in a power grid with different zones when training DRL agents.

FIG. 4 shows an exemplary computational flowchart of training a DRL agent for autonomous voltage control under contingencies.

FIG. 5 shows an exemplary information flowchart of the DRL agent training process.

FIG. 6 shows an exemplary one-line diagram of the IEEE 14 bus power grid model for testing the embodiment.

FIG. 7 shows an exemplary plot demonstrating the performance of DRL agent in the learning process using 10,000 episodes without considering contingencies.

FIG. 8 shows an exemplary plot demonstrating the performance of DRL agent in the learning process using 10,000 episodes considering N-1 contingencies.

FIG. 9 shows an exemplary plot demonstrating the performance of DRL agent on 10,000 episodes considering N-1 contingencies (exploration rate: 0.001, decay: 0.9, learning rate: 0.001).

FIGS. 10A-10B show exemplary plots demonstrating the DQN agent performance on IEEE 14-bus system with a larger action space: 625.

FIGS. 11A-11B show exemplary plots demonstrating the DQN agent performance on IEEE 14-bus system with an even larger action space: 3,125.

FIG. 12 shows an exemplary plot demonstrating a load center of the 200-bus model selected for testing DRL agents.

FIG. 13 shows an exemplary plot demonstrating DQN agent performance on the Illinois 200-bus system with an action space of 625.

FIG. 14 shows a detailed flowchart of training DQN agents for autonomous voltage control

### DETAILED DESCRIPTION OF THE ILLUSTRATED EMBODIMENTS

An autonomous voltage control schema for grid operation using deep reinforcement learning (DRL) is detailed next. In one embodiment, an innovative and promising approach of training DRL agents with improved RL algorithms provides data-driven, real-time and autonomous control strategies by coordinating and optimizing available controllers to regulate voltage profiles in a power grid, where the AVC problem is formulated as Markov decision process (MDP) so that it can take full advantages of state-of-the-art reinforcement learning (RL) algorithms that are proven to be effective in various real-world control problems in highly dynamic and stochastic environments.

One embodiment uses an autonomous control framework, named “Grid Mind”, for power grid operation that takes advantage of state-of-the-art artificial intelligent (AI) technology, namely deep reinforcement learning (DRL), and synchronized measurements (phasor measurement units) to derive fast and effective controls in real time targeting at the current and near-future operating conditions considering N-1 contingencies.

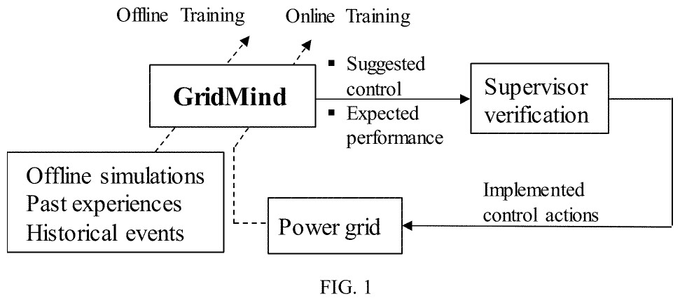

The architecture design of the embodiment is provided in FIG. 1, where the DRL agent is trained offline by interacting with massive offline simulations and historical events, which can also be updated periodically in online environment. Once abnormal conditions are detected in real time, the DRL agent provides autonomous control actions and the corresponding expected results. The control actions will be firstly verified by human operators before actual implementation in the field, to enhance robustness and guarantee performance. After the action has been taken in the power grid (environment) at the current state, the agent will receive a reward from the environment containing the next set of states, to evaluate the effectiveness of control policy. In the meantime, the relationship among actions, states and rewards are updated in the agent's memory. This process continues as the agent keeps learning and improving its performance over time.

A coordinated voltage control problem formulated as Markov decision process (MDP) is detailed next. An MDP represents a discrete time stochastic control process, which provides a general framework for modeling decision making procedure for a stochastic and dynamic control problem. For the problem of coordinated voltage control, a 4-tuple can be used to formulate the MDP:
(S, A, Pₐ, Rₐ)

where S is a vector of system states, including voltage magnitudes and phase angles across the system or areas of interest; A is a list of actions to be taken, e.g., generator terminal bus voltage setpoints, status of shunts and tap ratios of transformers; Pₐ(s, s′)=Pr(sₜ₊₁=s′|sₜ=s, aₜ=a) represents the transition probability from the current state sₜ to a new state, sₜ₊₁, after taking an action a at time=t; Rₐ(s, s′) is the reward received after reaching state, s′, from the previous state, s, to quantify the overall control performance.

Solving the MDP is to find an optimal “policy”, π(s), which can specify actions based on states so that the expected accumulated rewards, typically modelled as a Q-value function, Q^{π}(s, a), can be maximized in the long run, given by:

Q^{π}(s, a) = [symbol] (rₜ₊₁+γrₜ₊₂+γrₜ₊₃+ . . . |s, a) (1)

Then, an optimal value function is the maximum achievable value given as:

$${Q}^{*} ( s , a ) = {max}_{π} {Q}^{π} ( s , a ) = {Q}^{{π}^{*}} ( s , a ) \qquad ( 2 )$$

Once Q* is known, the agent can act optimally as:

$${π}^{*} ( s ) = arg {max}_{a} {Q}^{*} ( s , a ) \qquad ( 3 )$$

Accordingly, the optimal value that maximizes over all decisions can be expressed as:

$${Q}^{*} ( s , a ) = {r}_{t + 1} + γ {max}_{{a}_{t + 1}} {r}_{t + 2} + {γ}^{2} {max}_{{a}_{t + 2}} {r}_{t + 3} \qquad ( 4 )$$

Essentially, the process in Equations (1)-(4) is a Markov Chain process. Since the future rewards are now easily predictable by neural networks, the optimal value can be decomposed into a more condensed way as a Bellman equation:

$${Q}^{*} ( s , a ) = {𝔼}_{s} , [ r + γ {max}_{{a}^{′}} {Q}^{*} ( {s}^{′} , {a}^{′} ) ) \vert s , a ] \qquad ( 5 )$$

where γ is discounted factor. This problem can then be solved using many state-of-the-art reinforcement learning algorithms.

Artificial Intelligence is a process when computers try to solve specific tasks or problems by mimicking human's behavior; and machine learning (ML) is a subset of AI technologies by learning from data or observations and then making decisions based on trained models. ML consists of supervised learning, unsupervised learning, and reinforcement learning (RL), serving different purposes. Different from all other branches, RL refers to an agent that learns its action policy that maximizes the expected rewards based on interactions with the environment. Typical RL algorithms include dynamic programming, Monte Carlo and Temporal difference such as Q-learning. An RL agent continuously interacts with an environment; where the environment receives an action, emits new states and calculates a reward; and the agent observes states, suggests action to maximize next reward. Training an RL agent involves dynamically updating a policy (mapping from states to action), a value function (mapping from action to reward) and a model (for representing the environment).

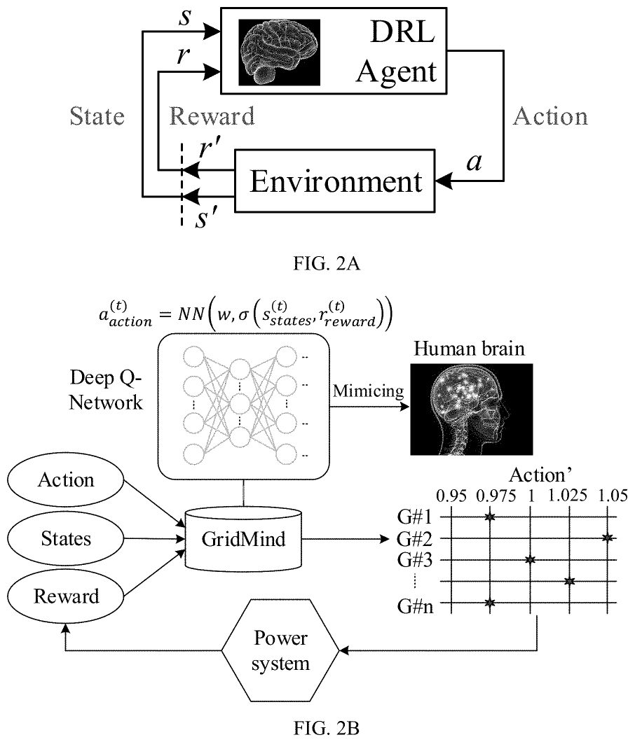

Deep learning (DL) provides a general framework for representation learning that consists of many layers of nonlinear functions mapping inputs to outputs. Its uniqueness rests with the fact that DL does not need to specify features beforehand. One typical example is the deep neural network. Basically, DRL is a combination of DL and RL, where DL is used for representation learning and RL for decision making. In the embodiment, deep Q network (DQN), is used to estimate the value function, which supports continuous state sets and is suitable for power grid control. The designed DRL agent in the framework for providing autonomous coordinated voltage control is shown in FIG. 2.

The goal of a well-trained DRL agent for autonomous voltage control is to provide an effective action from finite control action sets when observing abnormal voltage profiles. The definition of episode, states, action and reward is given below:

(1) Episode: An episode represents any operating condition collected from real-time measurement systems such as supervisory control and data acquisition (SCADA) or phasor measurement unit (PMU), under random load variations, generation dispatches, topology changes and contingencies. Contingencies are randomly selected and applied in this embodiment to mimic reality.

(2) States: The states are defined as a vector of system information that is used to represent system conditions, including active and reactive power flows on transmission lines and transformers, as well as bus voltage magnitudes and phase angles.

(3) Action Space: Typical manual control actions to mitigate voltage issues include adjusting generator terminal voltage setpoints, switching shunt elements, transformer tap ratios, etc. In this work, without loss of generality, the inventors consider generator voltage set point adjustments as actions to maintain system voltage profile. Each can be adjusted within a range, e.g., [0.95, 0.975, 1.0, 1.025, 1.05] p.u. The combination or permutation of all available generator setpoints forms an action space used to train a DRL agent.

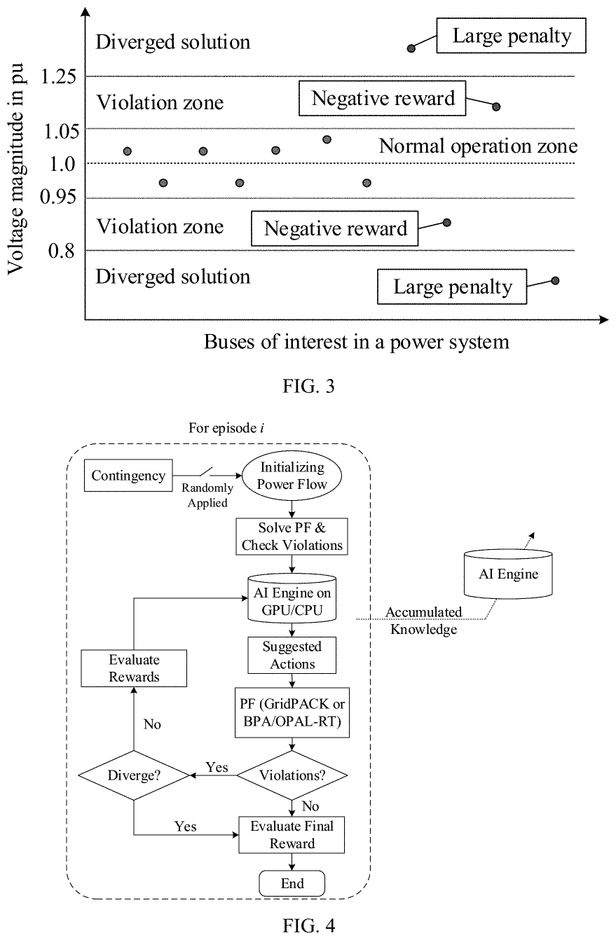

(4) Reward: Several voltage operation zones are defined to differentiate voltage profiles, including normal zone (0.95-1.05 pu), violation zone (0.8-0.95 pu or 1.05-1.25 pu) and diverged zone (>1.25 pu or <0.8 pu), as shown in FIG. 3.

Rewards are designed accordingly for each zone. In one episode (Ep), define Vᵢ as the voltage magnitude at bus i, and the reward for the j^{th} control iteration can be calculated as:

$${Reward}_{j} \{ \begin{matrix}large reward ( + 100 ) , ∀ {V}_{i} ∈ normal operation zone \\ large penalty ( - 100 ) , ∃ {V}_{i} ∈ diverged zone \\ negative reward ( - 50 ) , ∃ {V}_{i} ∈ violation zone\end{matrix} \qquad ( 6 )$$

The final reward for an entire episode containing n iterations is then calculated as the total accumulated rewards divided by the number of control iterations:

Final Reward=Σⱼ₌₁ⁿRewardⱼ/n (7)

In this way, a higher reward is assigned to very effective action (taking one control iteration only vs many action iterations) to solve the same voltage problem. With the above definition of DRL components, the computational flowchart of training a DRL agent is given in FIG. 4, which consists of several key steps:

Step 1: starting from one episode (real-time information collected in a power network), solve power flow and check potential voltage violations. A typical violation range can be defined as 0.95-1.05 p.u. for all buses of interest in the power system being studied;

Step 2: based on the states obtained, a reward value can be calculated, both of which are fed into the DRL agent; the agent then generates an action based on its observation of the current states and expected future rewards;

Step 3: the environment (e.g., AC power flow solver) takes the suggested action and solve another power flow. Then, bus voltage violations are checked again. If no more violation occurs, calculate the final reward for this episode and terminate the process of the current episode;

Step 4: if violation is detected, check for divergence. If divergence occurs, update the final reward and terminate an episode. If power flow converges, evaluate reward and return to Step 2.

The training process terminates when one of the three conditions is met: (1) no more violation occurs, (2) power flow diverges, or (3) the maximum number of iterations is reached.

Implementation details of training DRL agents are detailed next. There are mainly three reinforcement learning methods: model-based (e.g., dynamic programming method), policy-based (e.g., Monte Carlo method) and value-based (e.g., Q-learning and SARSA method). The latter two are model-free methods, indicating they can interact with the environment directly without the need for environment model, and can handle problems with stochastic transitions and rewards. One embodiment uses an enhanced Deep-Q network (DQN) algorithm and a high-level overview of the training procedure and implementation of the DQN agents is shown in FIG. 2. The DQN method is derived from the classic Q-learning method when integrated with DNN. The states, actions and Q-values in Q-learning method are stored in a Q-table. Obviously, it is not capable of handling a large dimension of states or actions. To resolve this issue, in DQN, neural networks are used to approximate the Q-function instead of using a Q-table, which allows continuous state inputs. The updating principle of Q-value NN in DQN method can be expressed as:

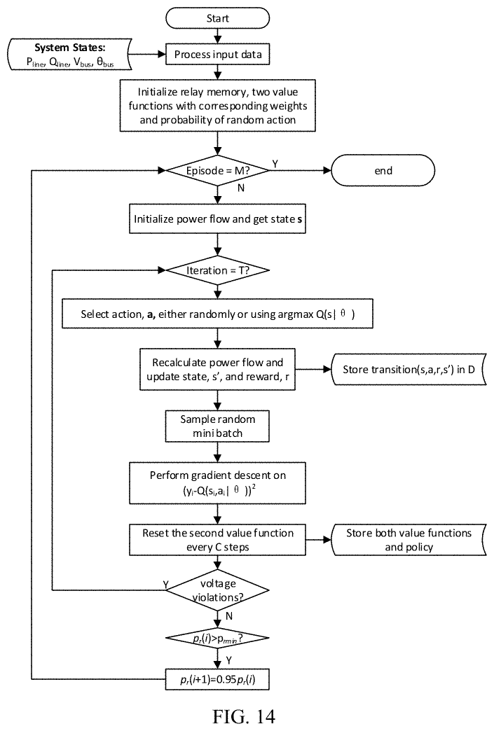

Q_{(s,a)}=Q_{(s,a)}+α[r+γmaxQ_{(s′,a′)}−Q_{(s,a)}] (8)

where α is the learning rate and y is the discount rate. The parameters of NN is updated by minimizing the error between the actual and estimated Q-values [r+γmaxQ_{(s′,a′)}−Q_{(s,a)}]. In this work, there are two specific designs making DQN a promising candidate for coordinated voltage control, namely experience replay and fixed Q-targets. Firstly, DQN has an internal memory to restore the past-experience and learn from it repeatedly. Secondly, to mitigate the overfitting problem, two NNs are used in the enhanced DQN method, with one being a target network and the other an evaluation network. Both networks share the same structure, but with different parameters. The evaluation network keeps updating its parameters with training data. The parameters of the target network are fixed and periodically get updated from the evaluation network. In this way, the training process of DQN becomes more stable. The pseudo code for training and testing the DQN agent is presented in Table I. The corresponding flowchart is given in FIG. 14.

TABLE I
ALGORITHM FOR TRAINING THE DQN AGENT

```
Input: system states (Pₗᵢₙₑ, Qₗᵢₙₑ, V_{bus}, θ_{bus})
Output: generator voltage set points
Initialize the relay memory R to capacity C
Initialize value function Q with weight θ
Initialize value function \hat{Q} with weight \hat{θ}
Initialize the probability of applying random action pᵣ(0)=1
for episode=1 to M do
  Initialize the power flow and get state s
  for iteration=1 to T do
    With probability ε select a random action a
    $Otherwise select a = arg {max}_{a} Q ( s \vert θ )$
    redo power flow, get new state s’ and reward r
    Store transition (s, a, r, s’) in D
    Sample random mini batch of transition (sᵢ, aᵢ, rᵢ, sᵢ′) in D
    $Set {y}_{i} = \{ \begin{matrix}{r}_{i} , & if episode terminates at i + 1 \\ {r}_{i} + γ {max}_{a} \hat{Q} ( s ’ , {a}^{′} \vert \hat{θ} ) , & otherwise\end{matrix}$
    Perform gradient descent on (yᵢ − Q(sᵢ, aᵢ|θ))² with respect to θ
    Reset \hat{Q} = Q every C steps
    if no voltage violations, end for
  while pᵣ(i) > Pᵣₘᵢₙ
  Pᵣ(i+1)=0.95 pᵣ(i)
end for
```

During the exploration period, the decaying E-greedy method is applied, which means the DQN agent has a decaying probability of ϵᵢ to make a random action selection at the i^{th} iteration. And ϵᵢ can be updated as

$${ɛ}_{i + 1} = \{ \begin{matrix}{r}_{d} \times {ɛ}_{i} , if {ɛ}_{i} > {ɛ}_{min} \\ {ɛ}_{min} , else\end{matrix} \qquad ( 9 )$$

where r_{d} is a constant decay rate.

The platform used to train and test DRL agents for autonomous voltage control is selected to be CentOS 7 Linux Operation System (64 bit). This server is equipped with Intel Xeon E7-8893 v3 CPU at 3.2 GHz and 528 GB memory. All the DRL training and testing process are performed on this platform.

To mimic real power system environment, a commercial power grid simulator is adopted, which is equipped with function modules such as power flow, dynamic simulation, contingency analysis, state estimation and so on. In this embodiment, only the AC power flow module, as environment, is applied to interact with the DRL agent. Intermediate files are used to pass information between the power flow solver and the DRL Agent, including power flow information file saved in PTI raw format and power flow solution results saved in text files.

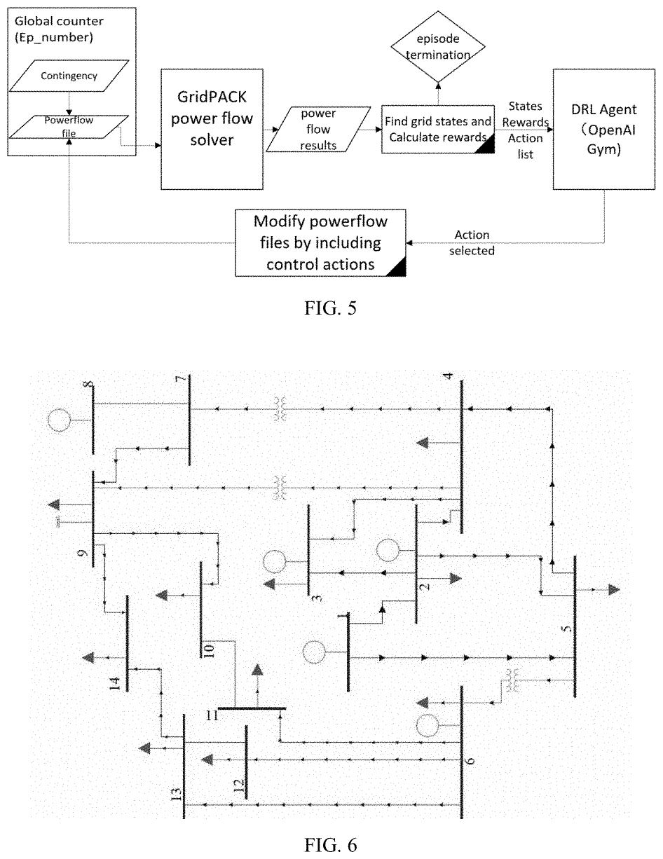

For DRL agent, the most recently developed DQN libraries in Anaconda is utilized, which is a popular python data science platform for implementing AI technologies. This platform provides useful libraries including Keras, Tensorflow, Numpy and others for effective DQN agent development. The Deep Q-learning framework is also used to set up the environment of DRL Agent and to interact with the environment, which is coded using Python 3.6.5 scripts. The information flow is given in FIG. 5.

Next, experimental validations of the instant system are discussed. One embodiment for autonomous voltage control is tested on the IEEE 14-bus system model and the Illinois 200-bus systems with tens of thousands realistic operating conditions, which demonstrate outstanding performance in providing coordinated voltage control for unknown system operating conditions. Extensive sensitivity studies are also conducted to thoroughly analyze the impacts of different parameters on DRL agents towards more robust and efficient decision making. This method not only effectively supports grid operators in making real-time voltage control decisions (for a grid without AVC); but also provides complimentary feature to the existing OPF-based AVC system at secondary and tertiary levels.

To generate massive representative operating conditions for training DRL agents, random load perturbations to different extent are applied to load buses across the entire system to mimic renewable generation variation and different load patterns. After load changes, generators are re-dispatched using a participation factor list determined by installed capacity or operation reserves to maintain system power balance. The commercial software package, Powerflow & Short circuit Assessment Tool (PSAT) developed by Powertech Labs in Canada, is used to generate massive random cases using python scripts for these two systems. Each case presents a converged power flow condition with or without voltage violations, saved in PTI format files. Over 83% of the created cases have voltage violation issues with respect to a safe zone of [0.95, 1.05] pu. More voltage issues in the created scenarios are preferred when training and optimizing DRL policies, as safe scenarios do not need to trigger corrective controls.
A. Case I—IEEE 14-Bus Model without Contingencies (action space: 120)

The IEEE 14-bus power system model consists of 14 buses, 5 generators, 11 loads, 17 lines and 3 transformers. The total system load is 259 MW and 73.5 MVAr. A single-line diagram of the system is shown in FIG. 6. To test the performance of the DRL agent, massive operating conditions to mimic reality are created and three case studies are conducted. In this case, permutation is used to remove repetitive control actions of all 5 generators in this power grid model, thus, forming an action space with a dimension of 120.

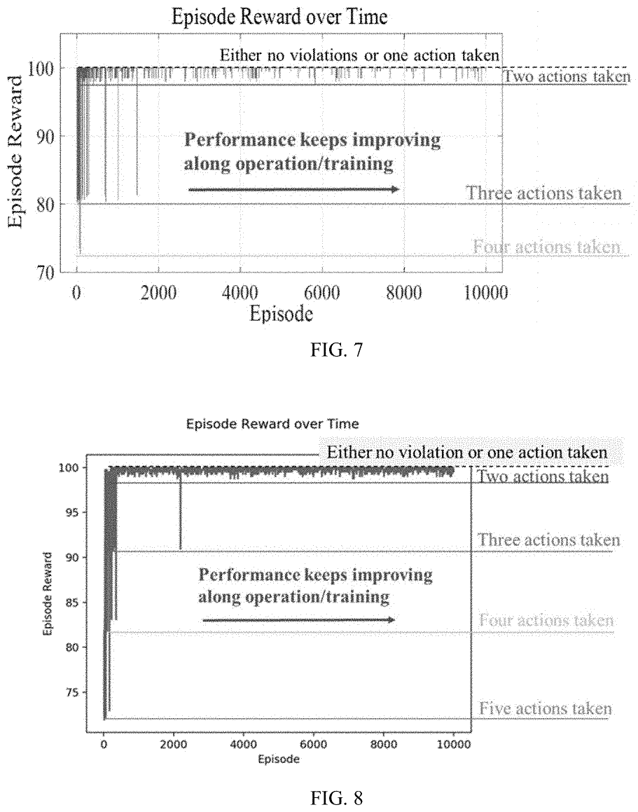

In Case I, all lines and transformers are in service without any topology changes. Random load changes are applied across the entire system, and each load fluctuates within 80%-120% of its original value. When loads change, generators are re-dispatched based on a participation factor list to maintain system power balance. 10,000 random operating conditions are created accordingly. A DRL agent is trained using the embodiment and its performance on the 10,000 episodes is shown in FIG. 7. The x-axis represents the number of episodes being trained; while y-axis represents the calculated final reward values. It can be observed that the rewards of the first few hundreds of episodes are relatively low, given that the agent starts with no knowledge about controlling the voltage profiles of the grid. As the learning process continues, the agent takes fewer and fewer control actions to fix voltage problems. It is worth mentioning that several parameters in the DQN agent play a role in deciding when to explore new random actions versus using existing models. These parameters include exploration rate, learning speed, decay and others, which need to be carefully tuned to achieve satisfactory performance. In general, when the agent performs well on a large number of unseen episodes, one can trust the trained model more and use it for online applications.

Table II explains the details of the agent's intelligence in Episode 8 and 5000. For the initial system condition in Episode 8, several bus voltage violations are identified, shown in the first row of Table II. To fix the voltage issues, the agent took an action by setting generator voltage setpoint to [1.05 1.025 1 0.95 0.975] for the 5 generators; after this action, the system observes less violations, shown in the second row of Table II. Then, the agent took a second action [1.025 0.975 0.95 1 1.05] before all the voltage issues are fixed. By the time the agent learns 4999 episodes, it accumulates sufficient knowledge: at the initial condition of Episode 5000, 6 bus voltage violations are observed, highlighted in the 4^{th} row of Table II. The agent took one action and corrected all voltage issues, using the policy that DQN memorizes.
B. Case II—IEEE 14-Bus Model Considering Contingencies (action space: 120)

In Case II, the same number of episodes are used, but random N-1 contingencies are considered to represent emergency conditions in real grid operation. Several line outages are considered, including lines 1-5, 2-3, 4-5, and 7-9. Each episode picks one outage randomly, before feeding into the learning process. Shown in FIG. 8, the DRL Agent performs very well when testing on these episodes with random contingencies. Initially, the agent never meets the episodes with contingencies before and thus takes more actions to fix voltage profiles. After several hundreds of trials, it can fix the voltage profiles using less than two actions for most of the episodes, which demonstrate its excellent learning capabilities.
C. Case III—Using Converged Agent with High Rewards (action space: 120)

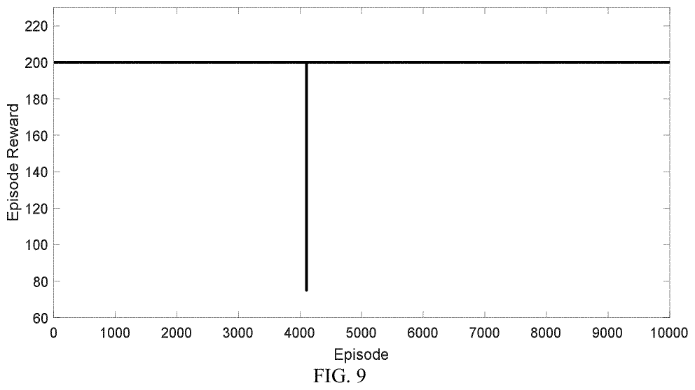

In Case III, the definition of final reward for any episode is revised so that a higher reward, in the value of 200, is issued when the agent can fix the voltage profile using only one control iteration; if there is any voltage violation in the states, no reward is given. Using the updated reward definition and the procedures in Case II to train an agent considering N-1 contingencies. Once the agent is trained, it is tested on a new set of 10,000 episodes randomly generated with contingencies, by reducing exploration rate to a very small value. The test performance is shown in FIG. 9, demonstrating outstanding performance in autonomous voltage control for the IEEE-14 bus system. The sudden drop in reward around Ep 4,100 is caused by exploration of a random action, leading to a few iterations before voltage problems are fixed.
D. Case IV—Training DQN Agent with Larger Action Space without Contingencies

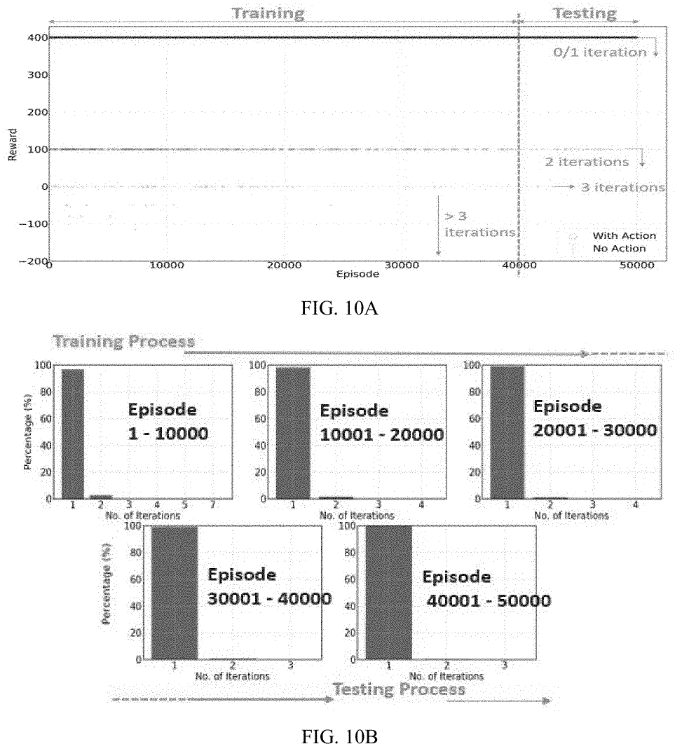

In this case study, the combination of 4 generator voltage setpoints (except the swing generator) is used to form an action space of 5⁴=625, where each generator can choose one out of five discrete values from a pre-determined list, [0.95, 1.05]. With the above procedures, a wide range of load fluctuations between 60% and 140% of their original values is applied and a total number of 50,000 power flow cases are successfully created. One DQN agent with both evaluation network and target network is trained and properly tuned, using the normalization and dropout techniques for improving its performance. FIG. 10 demonstrates the DQN performance in the training (using 40,000 episodes) and testing (using 10,000 episodes) phases. As observed in FIG. 10, rewards gained by the DQN agent continue to increase during the training phase, with initial rewards being negative, until very good scores are reached later in the training phase. During the testing phase, the DQN agent is able of correcting the voltage problems within one iteration most of the time. This case study further verifies the effectiveness of the DQN agent in regulating voltages for the 14-bus system. Note that the agent is capable of detecting the situation without any voltage violations and choosing not to take actions under that circumstance.

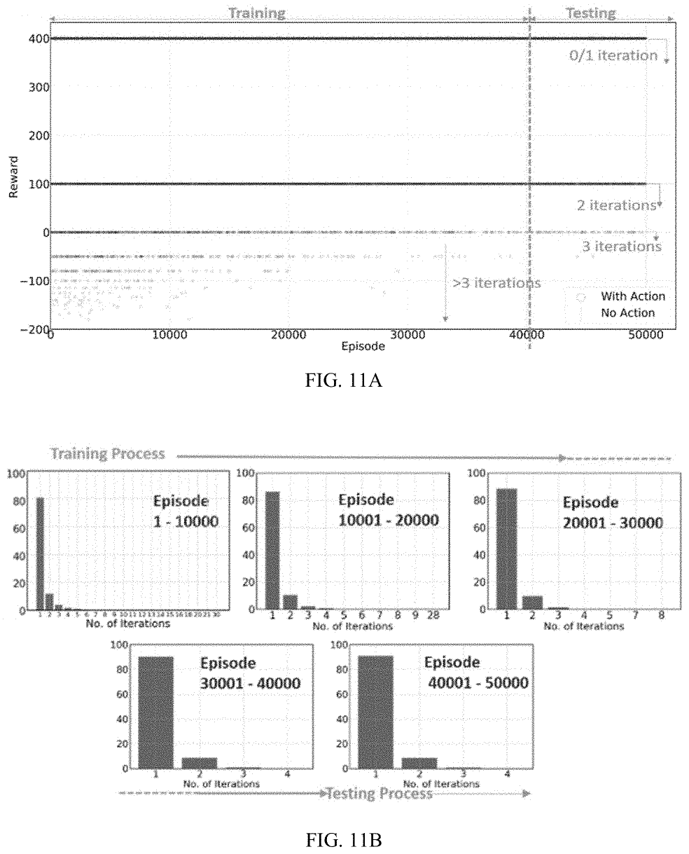

Another test is performed by including the swing generator as well for regulating system bus voltages, so that the dimension of action space becomes 3125 (5⁵). The corresponding DQN agent performance is shown in FIG. 11, where deterioration in both training and testing phases are observed, indicating the agent takes more control iterations than before in fixing voltage issues. Given the control space grows exponentially, a longer training period with larger set of episodes is required to obtain good control performance.
E. Case V—Training DQN Agent for the Illinois 200-bus Power Grid Model

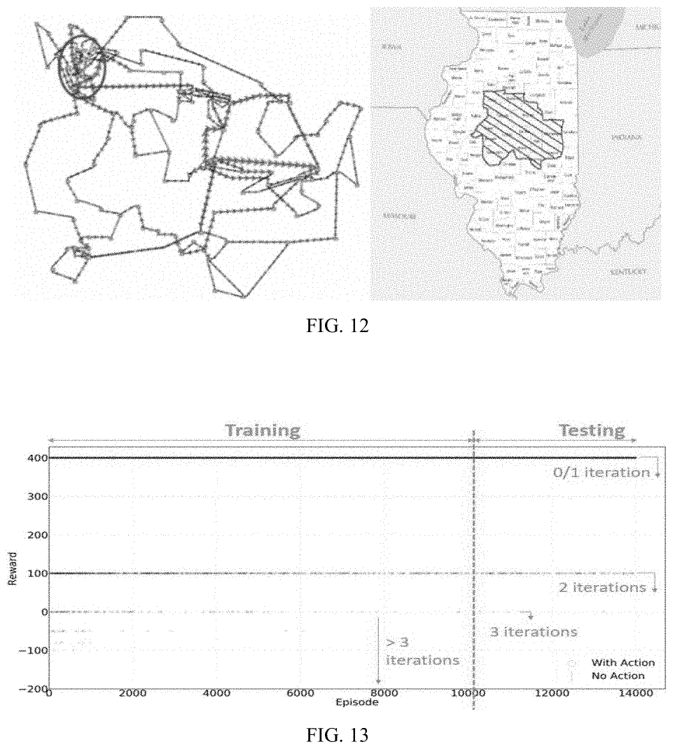

Furthermore, a larger power network, the Illinois 200-bus system, is used to test the performance of DRL agents. A heavy load area in the Illinois 200-bus system is tested, by using 5 generators for controlling 30 adjacent buses, shown in FIG. 12. A DQN agent with an action space of 625 are trained using 10,000 episodes, which are then tested on 4,000 unseen scenarios.

The performance of the DRL agent is shown in FIG. 13. As can be observed, the DRL agent demonstrates good convergence performance in the testing phase, which is consistent with the findings in the IEEE 14-bus system.

To effectively mitigate voltage issues under growing uncertainties in a power grid, this embodiment presents a novel control framework, Grid Mind, to use deep reinforcement learning for providing coordinated autonomous voltage control for grid operation. The architecture design, computational flow and implementation details are provided. The training procedures of DRL agents are discussed in detail. The properly trained Agents can achieve the goal of autonomous voltage control with satisfactory performance. It is important to carefully tune the parameters of the agent and properly set the tradeoff between learning and real-world application.

Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. A method to control voltage profiles of a power grid, comprising:
forming an autonomous voltage control model with one or more neural networks as Deep Reinforcement Learning (DRL) agents;
training the DRL agents to provide data-driven, real-time and autonomous grid control strategies; and
coordinating and optimizing reactive power controllers to regulate voltage profiles in the power grid with a Markov decision process (MDP) operating with reinforcement learning to control problems in dynamic and stochastic environments.

2. The method of claim 1, wherein the DRL agents are trained offline by interacting with offline simulations and historical events which are periodically updated.

3. The method of claim 1, wherein the DRL agent provides autonomous control actions once abnormal conditions are detected.

4. The method of claim 1, wherein after an action is taken in the power grid at a current state, the DRL agent receives a reward from the power grid.

5. The method of claim 1, comprising updating a relationship among action, states and reward in the agent's memory.

6. The method of claim 1, comprising solving a coordinated voltage control problem.

7. The method of claim 6, comprising performing a Markov Decision Process (MDP) that represents a discrete time stochastic control process.

8. The method of claim 6, comprising using a 4-tuple to formulate the MDP:
(S, A, Pₐ, Rₐ)
where S is a vector of system states, A is a list of actions to be taken, Pₐ(s, s′)=Pr(sₜ₊₁=s′|sₜ=s, aₜ=a) represents a transition probability from a current state sₜ to a new state, sₜ₊₁, after taking an action a at time=t, and Rₐ(s, s′) is a reward received after reaching state s′ from a previous state s to quantify control performance.

9. The method of claim 1, wherein the DRL agent comprises two architecture-identical deep neural networks including a target network and an evaluation network,

10. The method of claim 1, comprising providing a sub-second control with a phasor measurement unit (PMU) data stream from a wide area measurement system (WAMS).

11. The method of claim 1, wherein the DRL agent self-learns by exploring control options in a high dimension by moving out of local optima.

12. The method of claim 1, comprising performing voltage control by the DRL agent by considering multiple control objectives and security constraints.

13. The method of claim 1, wherein a reward is determined based on voltage operation zones with voltage profiles, including a normal zone, a violation zone, and a diverged zone.

14. The method of claim 1, comprising applying a decaying ϵ-greedy method for learning, with a decaying probability of ϵᵢ to make a random action selection at an i^{th} iteration, wherein ϵᵢ is updated as
$${ɛ}_{i + 1} = \{ \begin{matrix}{r}_{d} \times {ɛ}_{i} , if {ɛ}_{i} > {ɛ}_{min} \\ {ɛ}_{min} , else\end{matrix}$$
an r_{d} is a constant decay rate.

15. A method to control voltage profiles of a power grid, comprising:
measuring states of a power grid;
determining abnormal voltage conditions and locating affected areas in the power grid;
creating representative operating conditions including contingencies for the power grid;
conducting power grid simulations in an offline or online environment;
training deep-reinforcement-learning-based agents for autonomously controlling power grid voltage profiles; and
coordinating and optimizing control actions of reactive power controllers in the power grid.

16. The method of claim 15, wherein the measuring states comprises measuring from phasor measurement units or energy management systems.

17. The method of claim 15, comprising generating data-driven, autonomous control commands for correcting voltage issues considering N-1 contingencies in the power grid.

18. The method of claim 15, comprising presenting expected control outcomes once the DRL-based commands are applied to a power grid.

19. The method of claim 15, comprising providing a sub-second control with a phasor measurement unit (PMU) data stream from a wide area measurement system (WAMS).

20. The method of claim 15, comprising providing a platform for data-driven, autonomous control commands for regulating voltages, frequencies, line flows, or economics in the power network under normal and contingency operating conditions.
